(19) United States
(12) Patent Application Publication
(10) Pub. No.: US 2013/0270254 A1
(43) Pub. Date: Oct. 17, 2013

(54) HEATING DEVICE HAVING IMPROVED TEMPERATURE REGULATION SYSTEM

(71) Applicant: TENACTA GROUP A.P.A, Azzano S. Paolo BG (IT)

(72) Inventors: Arturo Morgandi, Azzano S. Paolo BG (IT); Giorgio Caccia, Azzano S. Paolo BG (IT)

(73) Assignee: Tenacta Group A.p.A, Azzano S. Paolo BG (IT)

(21) Appl. No.: 13/862,916

(22) Filed: Apr. 15, 2013

(30) Foreign Application Priority Data
Apr. 17, 2012 (IT) MI2012A000621

(51) Int. Cl. H05B 1/02

(52) U.S. Cl. CPC H05B 1/0272
USPC 219/494

(57) ABSTRACT

A heating device includes a main body able to house in its interior at least one heating element having means to adjust the temperature of such a heating element, characterized in that the heating device further comprises a system able to determine the possible variation of the temperature of the heating element according to the amount of energy provided to the heating element.

Examples of such a heating device include heating pads, electro-blankets, heating mats and the like. A related method for possibly vary such temperature of the heating element is also disclosed. The heating device is capable of maintaining the temperature of the outer surface of the heating device within predetermined limits of efficiency and safety to the user.

### CROSS REFERENCE

This application claims priority to Italian Patent Application No. MI2012A000621, filed Apr. 17, 2012, which is expressly incorporated in its entirety by reference herein.

### Field of the Invention

The present invention relates to a heating device, such as electro-blanket, bed warmers, heating pad or heating mat; in particular it relates to a heating device provided with a regulation system to maintain its surface temperature within predetermined limits and to a method for vary such a temperature.

### BACKGROUND OF THE INVENTION

Electro-blankets, heating pads, bed warmers, heating mats and the like, hereafter generically referred to as “heating devices” have long been known; they are electrical devices of various sizes that produce and transmit heat to the human body. Typically, these heating devices are provided within them of an electric circuit which, when activated, transmits heat to the user when he/she is in rest conditions, in bed or sitting. Generally, heating pad means a portable fabric device, of smaller dimensions than electro-blankets or bed warmers, such that it can be applied to specific parts of the body, such as on the belly, back, neck or the like.

Typically, such heating devices are constituted by a main body, the outer surface of which is such as to be placed in contact with the human body, and by a heating element positioned within such a main body.

Typically, in some of such conventional heating devices, the temperature of the heating element is kept constant by a suitable regulator which measures the heating element temperature by means of a temperature sensor, integrated into the device. Since this temperature sensor is integrated into the heating device, it measures the internal temperature of the heating device itself, while the temperature of the device outer surface will change in function of both the temperature of the heating element, and according to the environment condition wherein the heating device itself is located. Typically conventional devices are also provided with a timing device that, after a pre-determined time period during which higher surface temperature values are allowed, for example 90 minutes, reduces the temperature to lower values. Typically, for example in the case of heating pads, the timing device reduces the temperature so that the surface is lower than 50° C., or alternatively switches off the device so as to fall within the temperature limits imposed by the safety standards IEC60335-2-17. An example of such a solution is described in patent EP1634483B1.

In view of the fact that the outer surface of the heating device is the portion that is in contact with the user, it is important that the temperature of such a surface is maintained within predetermined limits, comfortable and especially safe to the user.

Therefore, the technical problem faced by the Applicant of the present application is to provide a heating device comprising a suitable system able to maintain the outer surface temperature of the heating device within predetermined limits of efficiency and safety to the user, regardless of the usage and environmental conditions.

### SUMMARY OF THE INVENTION

In a first aspect the present invention relates to a heating device such as that indicated in claim 1.

The Applicant of the present application has in fact surprisingly found that a heating device comprising a main body able to house in its interior at least one heating element, wherein said heating device comprises means to adjust the temperature TR of said heating element, characterized in that said heating device further comprises a system F able to determine the possible variation of said temperature TR of the heating element according to the amount of energy provided to said heating element, is able to maintain the temperature of the outer surface of the heating device within predetermined limits of efficiency and safety to the user.

Said main body of the heating device of the present invention has an outer surface that comes into contact and interacts with the user, the temperature of said outer surface being subject to variation according to the environment conditions wherein the heating device is located.

The heating device of the invention therefore allows, through the system F, to act on the temperature TR of the heating element so that the temperature of the outer surface of the heating device itself can achieve and maintain for long time such temperature values to provide excellent heat transmission performance to the user's body to which the heating device of the present invention is applied, even when said heating device is used in the open air. Preferably, said heating device is an electric-blanket, an electric warming bed, heating pad, a heat mat or any electrical device designed to heat a bed or other similar surface, or to heat the human body in a bed or otherwise at rest.

Preferably, said heating device is of any size, such as for example to completely cover a bed or a portion of it or a portion of the human body or a portion of a floor.

Preferably, said heating device is made of fabric, such as an envelope consisting of two fabric or felt layers glued or sewn together inside which at least one heating element is housed arranged in serpentine on all or part of the surface.

This way a greater diffusion of the heat provided from said heating element is obtained, thus allowing said heat to reach virtually all of the heating device in order to achieve a better heating of the surface to which the heating device is applied.

Preferably, said heating element comprises at least one electrical wire able to be connected to a battery or to a source of electrical energy, so as to be heated by it when activated.

Said means able to adjust the temperature TR of said heating element may be means known in the art. Preferably, said means comprise a switching device which activates/deactivates the heating element, a temperature measuring device of the heating element and a device directly activated by the user allowing the desired temperature selection. Preferably, said measuring device is an electronic circuit that takes advantage of the impedance variation of the of the heating element as a function of its temperature or, alternatively, an electronic circuit that uses NTC type probes applied so as to be heated by the heating element itself.

Preferably, the maximum value of said temperature TR of the heating element housed inside the heating device of the present invention is pre-set to a value in the range between 50° C. and 90° C., more preferably in the range between 60° C. and 85° C.

This way, the outer surface temperature of the heating device of the present invention reaches temperatures comfortable to the user.

Preferably, said measuring device, in the case wherein the heating device for any reason reaches a temperature considered excessive to the user safety, sends a signal to a regulator E, which shall revert said temperature to said preset value.

Preferably, said system F, able to determine the possible variation of said temperature TR of the heating element according to the amount of energy provided to said heating element, induces a temperature regulator to possibly vary said temperature TR. More preferably, said system F induces said regulator E to possibly varying said temperature TR.

In a first embodiment, said system F is able to determine the possible variation of said temperature TR of the heating element according to the amount of time taken to provide a pre-determined amount of said energy to the heating element itself.

Preferably, said system F comprises an energy meter which measures said energy provided to the heating element over time; most preferably, said energy is expressed in Wh.

Furthermore, preferably, said system F comprises a time counter able to detect the time t1 elapsed since the energy calculation provided to the heating element has been activated to when said energy measurement reaches the predefined amount E1.

Under standard conditions, i.e. in the environmental conditions such as ambient temperature and thermal insulation with which the appliance is insulated as defined by the safety standards IEC60335-2-17, the energy absorbed by the heating element is measurable and has a well-defined and repeatable value. It is therefore easily possible to predefine said amount of energy provided to the heating element E1.

Preferably, said system F is able to determine the possible variation of said temperature TR of the heating element based on a comparison between the time t1 required to reach said energy value E1 and a predefined time t2.

Preferably, if from said comparison it appears that t1 is greater than t2 (t1>t2), said system F determines the reduction of temperature TR of the heating element so as to low the temperature of said outer surface of the heating device.

Therefore, if the temperature difference between the heating element and the environment is low, or if the product is used in the insulated form, the energy provided to the heating element will be low, and the outer surface of the heating device will be hotter than in standard conditions.

Preferably, in this case, said system F determines the reduction of temperature TR of the heating element so that the temperature of the outer surface of the heating device is reduced, falling within the safety limits provided by the safety standard IEC 60335-2-17, i.e. below 50° C., preferably, in the range between about 40° C. and 50° C.

Vice versa, if from said comparison it appears that t1 is less than or equal to t2 (t1≦t2), in an embodiment said system F determines that the temperature TR of the heating element remains substantially unaltered. In another embodiment, said system F determines the increase of the temperature TR of the heating element up to an appropriate value.

More preferably, if t1 is less than 90% of the value of t2, said system F determines the increase of the temperature TR of the heating element of a value of at least 5° C.

Even more preferably, if t1 is less than 80% of the value of t2, said system F determines the increase of the temperature TR of the heating element of a value of at least 10° C.

This way, if the temperature difference between the heating element and the environment is high, or if the product is used in the open air, the energy provided to the heating element will be high, and the outer surface of the heating device will be colder than in standard conditions. By increasing the temperature TR of the heating element, more comforts are assured to the user even in cold environments.

Preferably, said heating device is also provided with an auto-off device able to switch off the heating element after a pre-determined period of time; most preferably, said heating device automatically switch off approximately 3 hours after the ignition.

This way, the heating device is provided with an additional device for the user safety.

Therefore, the Applicant of the present application has observed that the heating device is particularly useful for increasing performance when the device is used in place over the person (and then uncovered, that is directly in contact with the air), while maintaining the safety principle consisting in a not high outer surface temperature when said heating device is used in a covered and/or suffocated state, and thus improved compared to conventional products that provide poor performance when used in the open air.

In a second embodiment, said system F is able to determine the possible variation of the temperature TR of said heating element according to the amount E2 of said energy provided to the heating element itself in a pre-determined period of time t3, by comparing said energy E2 with a pre-defined energy E3.

Similarly to what has been seen above with reference to the first embodiment, if by comparing said values of energy provided to the heating element it appears that E2 is lower than E3 (E2<E3), preferably said system F determines the reduction of the temperature TR of the heating element so as to lower the temperature of said outer surface of the heating device.

Vice versa, if from said comparison it appears that E2 is greater than or equal to E3 (E2≧E3), in an embodiment said system F determines that the temperature TR of the heating element remains substantially unaltered. In another embodiment, said system F determines the increase of the temperature TR of the heating element up to an appropriate value.

Preferably, if from such described above energies comparison it appears that E2 is considerably greater than E3, e.g. E2 is greater than a value that is equal to the E3 value increased by 10%, said system F determines the increase of the temperature TR of the heating element of about 5° C.

More preferably, if from such described above energies comparison it appears that E2 is greater than a value that is equal to the E3 value increased by 20%, said system F determines the increase of the temperature TR of the heating element of about 10° C., in order to ensure more comforts even in very cold environments.

In a second aspect, the present invention relates to a method for regulating the heating device temperature as the one indicated in claim 13.

The Applicant of the present application has in fact surprisingly found that a method for possibly vary the temperature TR of the heating element positioned within the main body of a heating device, characterized in that said possible variation of temperature TR is according to the amount of energy provided to said heating element, is able to maintain said outer surface temperature of the heating device within predetermined limits of efficiency and safety to the user.

Preferably, said method adjusts the outer surface temperature of a heating device such as the described above heating device.

In one embodiment, preferably the method of the present invention comprises the following steps:
a) adjusting the temperature TR of the heating element 2;
b) measuring the amount of energy provided to said heating element, expressed in Wh;
c) detecting the elapsed time t1 required to allow said energy amount provided to the heating element 2 to be equal to a pre-defined value E1;
d) comparing said detected time t1 with a pre-defined time value t2;
e) possibly varying said temperature TR of said heating element 2 according to said comparison between t1 and t2.

In another alternative embodiment, preferably the method of the present invention comprises the following steps:
a) adjusting the temperature TR of the heating element 2;
b) measuring a period of time during which energy is provided to said heating element 2;
c) detecting the amount of energy E2, expressed in Wh, provided to said heating element 2 in a pre-defined time t3;
d) comparing said detected energy E2 with a pre-defined energy value E3;
e) possibly varying said temperature TR of said heating element 2 according to said comparison between E2 and E3.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a schematic view of an embodiment of a heating device of the present application;

FIG. 2 shows a graph of the performance of a heating pad of the invention in “covered” position;

FIG. 3 shows a comparison graph between the performance of a heating pad of the invention (track 1) and a conventional heating pad, in “uncovered” position (track 2);

FIG. 4 shows a graph of the performance of a heating pad of the invention in “uncovered” position showing a time t1 much smaller than the predefined time t2;

FIG. 5 shows a block diagram referring to an embodiment of the method of the present application to adjust the temperature of a heating device.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

The following detailed description refers to a particular embodiment of a heating device according to the present invention, without limiting the content thereof.

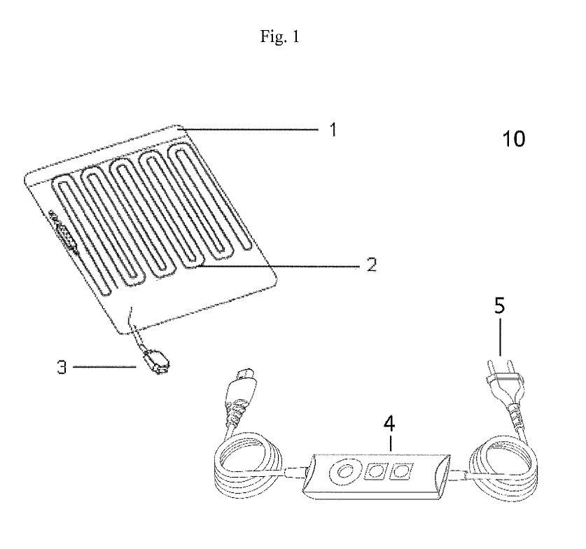

Referring to FIG. 1, a heating device 10 according to the present invention (herein also defined as a heating pad TF1) is described, comprising a main body 1 having an outer surface, which is that one which comes into contact with a portion of the user body to be heated; inside the main body 1 is housed the heating element 2, constituted by an electrical wire arranged in serpentine. From this structure an electric cable protrudes and, optionally, also protrudes a connector 3 which connects the heating element 2 to a control and adjustment device 4, which will be connected in turn to a battery or to a power source (not shown) through another electric cable 5.

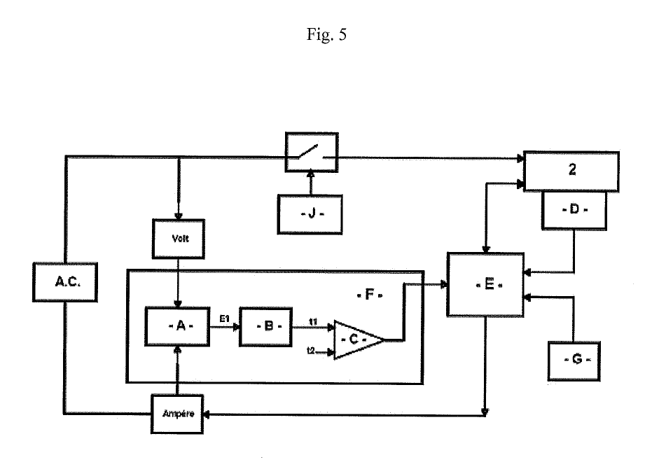

With reference to FIG. 5, a block diagram is shown that describes the method to adjust the temperature implemented within the control and adjustment device 4 of the heating pad TF1 of FIG. 1 according to an embodiment of the present application.

In this embodiment, the user pre-sets the initial temperature TR of the heating element 2 equal to about 80° C. (step G); one sensor D, which exploits the impedance variation of at least one conductor of the heating element 2 when the temperature varies, sends a signal to the regulator E which provide to keep the temperature TR to the pre-set value.

The system F measures the amount of energy provided to the heating element 2 as follows. An energy meter measures the energy E1 transferred to the heating element 2 over time (phase A), a time counter detects the time t1 which has elapsed since the meter of energy provided to the heating element 2 has been activated up to when the energy amount provided to the heating element 2 is equal to a predefined amount E1 (phase B), a comparison device compares the time t1 detected by the time counter with a preset time t2 (step C).

The comparison result between t1 and t2 determines the action type that the system F induces the regulator E to apply, i.e. the temperature TR variation, by decreasing it (if t1>t2), or by possibly increasing it (if t1≦t2).

For greater safety, the heating pad TF1 is also provided with an auto-off device (step J), for switching off the heating pad in any case for example 3 hours after the ignition, in order to avoid that the product remains forgotten unnecessarily turned on for long time.

### EXAMPLES

### Example 1 (Invention)

Heating pad TF1 of the invention was placed in the “covered” position in a special test bed as defined by the safety standard IEC 60335-2-17. Predefined energy values E1 were set to be 5 Wh, and time t2 was set at 30 minutes. Heating pad TF1 was then activated, by connecting the electric cable 5 to a power outlet; the heating element 2 was then brought to a initial constant temperature TR equal to 80° C. In such a covered position in the test bed, the heating pad TF1, being more insulated and therefore failing to come in contact with the environment, quickly reached high temperatures and with low energy waste.

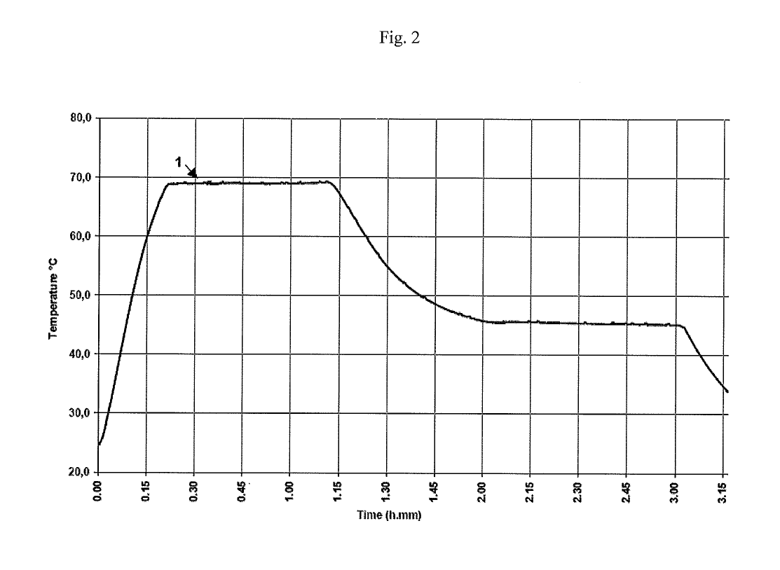

After 40 minutes the device F detected that the predefined value E1 of energy provided to the heating element 2 had been reached. Being such a time value t1 measured after 40 minutes greater than the predefined time t2 (30 minutes), this meant that the time t1 required to provide the predefined energy E1 of 5 Wh to the heating element 2 of the heating pad TF1 was high. In this case, the system F induced the regulator E to reduce the temperature TR of the heating element 2 to a value lower than 50° C., so as to lower the outer surface temperature of the heating pad TF1 and keep it within acceptable limits for the user. The example of temperature graph of the outer surface of the heating pad TF1 according to the invention is shown in FIG. 2.

### Example 2 (Invention)

The above described heating pad TF1 of the invention was placed, on one hand, in direct contact with the user body in a suitable position (belly, back or other anatomical part) and, on the other hand was covered with a cushion which constituted a thermal insulation between the heating pad TF1 and the external environment where the temperature was 20° C. The predefined values of energy E1 equal to 5 Wh, and time t2 equal to 30 minutes were set. The heating pad TF1 was then activated, by connecting the electric cable 5 to a power outlet; the heating element 2 was then brought to an initial constant temperature TR equal to 80° C.

After 40 minutes the device F detected that the predefined value E1 of energy provided to the heating element 2 had been reached. Being such a time value t1 measured after 40 minutes greater than the predefined time t2 (30 minutes), this meant that the time t1 required to provide the predefined energy E1 of 5 Wh to the heating element 2 of the heating pad TF1 was high. In this case, the system F induced the regulator E to reduce the temperature TR of the heating element 2 to a value of 50° C., so as to lower the outer surface temperature of the heating pad TF1 and keep it within acceptable limits for the user. The example of temperature graph of the outer surface of the heating pad TF1 according to the invention is shown in FIG. 2.

The heating pad TF1 of the invention thus presented the dual advantage of allowing the outer surface of the heating pad itself to achieve, first and for a not too long time as required by the standard IEC60335-2-17, a temperature such as to give good heat transmission performance to the user body and, subsequently, to reduce such a temperature only when it could constitute a danger to the user safety, based on the energy value E1 provided to the heating element 2 housed inside the heating pad TF1.

### Example 3 (Invention)

The above described heating pad TF1 was placed, on one side, in direct contact with the user body in a suitable position (belly, back or other anatomical part), as in the position defined above in Example 2, while the other side was left directly exposed to the outside environment where the temperature was 20° C. The E1 and t2 values were set as in Example 2.

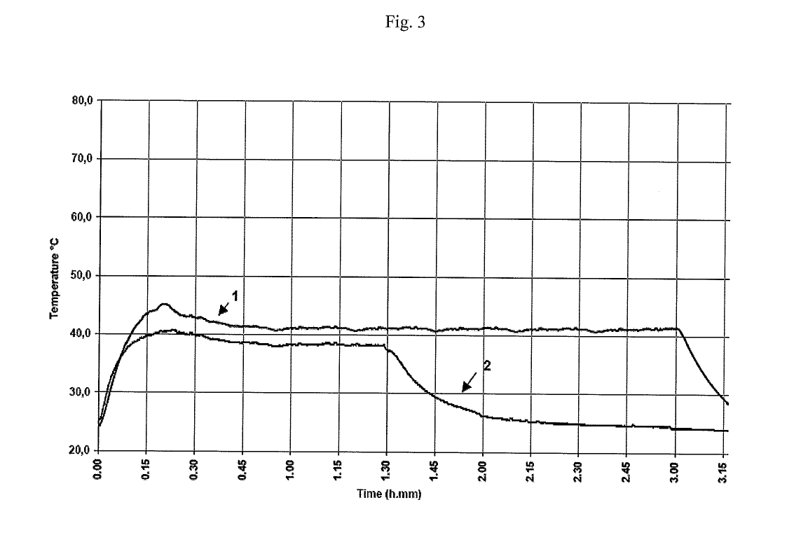

In this case, the device F detected that the predefined value E1 of energy provided to the heating element had been reached after 28 minutes. Being such a measured time t1 (28 minutes) shorter than the predefined time t2 (30 minutes), this meant that the time t1 required to provide the predefined energy E1 to the heating element 2 was low. In such conditions, the system F induced the regulator E to leave substantially unchanged the temperature TR of the heating element 2. In addition, for better security, the heating pad TF1, provided with the auto-switch off device mentioned above (step J), was switched off 3 hours after its ignition. The example of a temperature graph of the outer surface of the heating pad TF1 according to the invention described in this Example 3 is shown in FIG. 3, and referred to as track 1.

### Example 4 (Invention)

The above described heating pad TF1 was placed in the same conditions of Example 3, with the difference that in this case the system F detected that the predefined value E1 of energy provided to the heating element had been reached after only 23 minutes.

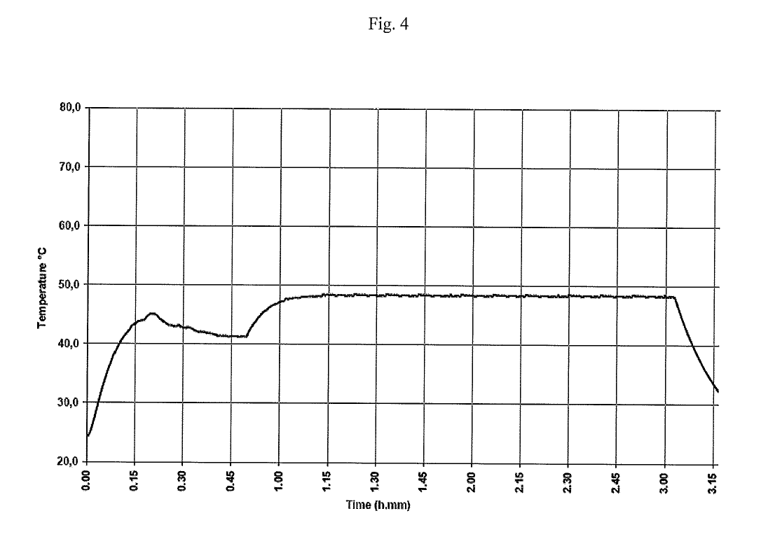

Being such a measured time t1 (23 minutes) lower than 80% of the predefined time t2 (30 minutes), this meant that the time t1 required to provide the predefined energy E1 to the heating element 2 was very low. In such conditions, the system F induced the regulator E to increase the temperature TR of the heating element 2 of 10° C., bringing thus it up to 90° C. (see the graph of FIG. 4), to compensate the considerable low environment temperature. In this case, the heating pad of the invention TF1 allowed to its outer surface to remain longer at a sufficiently high temperature to give good heat transmission performances, but still below the danger limits for the user.

### Example 5 (Comparison)

A conventional heating pad TF2, equipped with a fixed time auto-switch off device, but in absence of the F system present in the heating pad TF1 of the invention, was placed in the same position conditions of the heating pad TF1 as described in Example 3.

In the absence of the F system that allowed the heating pad TF1 to continue to provide high performance for a period of 3 hours, before the auto-switching off, the conventional heating pad TF2 switched off the heating element 2 after only 90 minutes as bound by the safety requirements imposed by the IEC 60335-2-17.

In the graph of FIG. 3 a comparison between the temperature reached by the outer surface of the heating pad TF1 of the invention and that one reached by the comparison heating pad TF2 is shown, both placed in the position as described in Example 3. In this graph, the continuous track 1 shows the behavior of the heating pad TF1 of the invention, which maintained a constant temperature, as highest as possible consistent with the use conditions, as desired by the user. Instead, the dotted track 2 shows that the comparison heating pad TF2, in absence of the system F, reached sufficient values to allow a good warming of the user body, but for 90 minutes only, interrupting the heat supplying much earlier than the heating pad TF1 of the invention.

The preferred embodiments of the invention have been described above to explain the principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

1. A heating device, comprising:
a main body able to house in its interior at least one heating element (2);
means to adjust the temperature of said heating element;
a system able to determine the possible variation of said temperature of the heating element according to the amount of energy provided to said element heating.

2. The heating device according to claim 1, wherein said heating device is selected from the group consisting of an electric-blanket, an electric bed warmer, a heating pad, a heating mat and a electrical device able to heat a bed or a floor or other similar surfaces, or to heat a human body in a bed or in any case at rest.

3. The heating device according to claim 1, wherein the maximum value of said temperature of said heating element is adjusted at a value comprised in the range between 50° C. and 90° C.

4. The heating device according to claim 1, wherein said system is operable to determine a possible variation of said temperature of said heating element according to an amount of time needed to provide a pre-determined amount of said energy to the heating element.

5. The heating device according to claim 1, wherein said system further comprises an energy measuring device which measures said amount of energy and a time counter operable to detect an amount of time elapsed from a first time in which said measurement of said amount of energy provided to the heating element has been activated to a second time in which said energy measurement reaches a predefined energy amount.

6. The heating device according to claim 1, wherein said system is operable to determine a possible variation of said temperature of the heating element according to a comparison between a detected time and a predefined time.

7. The heating device according to claim 6, wherein, if from said comparison it results that said detected time is greater than said predefined time, said system determines the reduction of said temperature of the heating element, and, if it results that said detected time is less than or equal to said predefined time, said system determines the possible increase of said temperature of the heating element.

8. The heating device according to claim 7, wherein, if said detected time is lower than 90% of said predefined time, said system determines the increasing of said temperature of the heating element of a value of at least 5° C.

9. The heating device according to claim 7, wherein, if said detected time is lower than 80% of said predefined time, said system determines the increasing of said temperature of the heating element of a value of at least 10° C.

10. The heating device according to claim 7, wherein, if from said comparison it results that said detected time is less than or equal to said predefined time, said system determines that said temperature of the heating element remains substantially unvaried.

11. The heating device according to claim 1, wherein said system is operable to determine a possible variation of said temperature of the heating element according to an amount of said energy provided to the heating element in a pre-determined period of time, by comparing said amount of said energy with a pre-defined amount of energy.

12. The heating device according to claim 1, further comprising a device operable to switch off the heating element after a pre-determined period of time.

13. The method according to claim 15, wherein said adjustment of said temperature is according to the amount of energy provided to said heating element.

14. The method according to claim 13, wherein said method possible varies the temperature of said heating element positioned within a heating device as the heating device described in claims 1.

15. A method for adjusting a temperature of a heating element positioned within a main body of a heating devise, comprising the following steps:
a) adjusting the temperature of the heating element;
b) measuring an amount of energy provided to said heating element, expressed in Wh;
c) detecting an elapsed time required to allow said energy amount provided to the heating element to be equal to a pre-defined value;
d) comparing said detected elapsed time with a pre-defined time value;
e) adjusting said temperature of said heating element according to said comparison between said detected elapsed time and said pre-defined time value.

16. A method for adjusting a temperature of a heating element positioned within a main body of a heating devise, comprising the following steps:
a) adjusting a temperature of the heating element;
b) measuring a period of time during which energy is provided to said heating element;
c) detecting an amount of energy, expressed in Wh, provided to said heating element in a pre-defined time;
d) comparing said detected amount of energy with a pre-defined energy value;
e) adjusting said temperature of said heating element according to said comparison between said detected amount of energy and said pre-defined energy value.
